(19) United States
(12) Patent Application Publication
(10) Pub. No.: US 2019/0130631 A1
(43) Pub. Date: May 2, 2019

(54) SYSTEMS AND METHODS FOR DETERMINING HOW TO RENDER A VIRTUAL OBJECT BASED ON ONE OR MORE CONDITIONS

(71) Applicant: Tsunami VR, Inc., Del Mar, CA (US)

(72) Inventors: Morgan Nicholas Gebbie, Carlsbad, CA (US); Bertrand Haddad, Carlsbad, CA (US)

(21) Appl. No.: 16/177,082

(22) Filed: Oct. 31, 2018

Related U.S. Application Data
(60) Provisional application No. 62/580,128, filed on Nov. 1, 2017.

(51) Int. Cl. G06T 15/10; G06T 7/73; G06T 7/536; G06T 19/20

(52) U.S. Cl. CPC G06T 15/10; G06T 19/20; G06T 7/536; G06T 7/73

(57) ABSTRACT

Systems, methods, and computer readable media for rendering a virtual object in a virtual environment are provided. The method can include determining a pose of a user and determining a viewing area of the user in the virtual environment based on the pose. The method can include defining a viewing region within the viewing area, the viewing region having a volume described by an angular displacement from a vector extending outward from the user in the virtual environment. The method can include identifying a virtual object in the viewing area of the user and causing the user device to display a version of a plurality of versions of the virtual object via the user device based on one or more of a distance to the virtual object, a viewing region in relation to the virtual object, an interaction with the virtual object, and a reference to the virtual object.

### CROSS REFERENCE TO RELATED APPLICATIONS

This application claims priority to U.S. Provisional Patent Application Ser. No. 62/580,128, filed Nov. 1, 2017, entitled “SYSTEMS AND METHODS FOR DETERMINING HOW TO RENDER A VIRTUAL OBJECT BASED ON ONE OR MORE CONDITIONS,” the contents of which are hereby incorporated by reference in their entirety.

### BACKGROUND

### Technical Field

This disclosure relates to virtual reality (VR), augmented reality (AR), and hybrid reality technologies.

### Related Art

Mixed reality (MR), sometimes referred to as hybrid reality, is the term commonly applied to the merging of real or physical world and virtual worlds to produce new environments and visualizations where physical and digital objects co-exist and interact. Mixed reality visualizations and environments can exists in the physical world, the virtual world, and can include a mix of reality, VR, and AR via immersive technology.

### SUMMARY

An aspect of the disclosure provides a method for rendering a virtual object in a virtual environment on a user device. The method can include determining a pose of a user. The method can include determining a viewing area of the user in the virtual environment based on the pose. The method can include defining a viewing region within the viewing area, the viewing region having a volume described by an angular displacement from a vector extending outward from the user in the virtual environment. The method can include identifying a virtual object in the viewing area of the user. The method can include causing the user device to display a version of a plurality of versions of the virtual object via the user device based on one or more of a distance to the virtual object, a viewing region in relation to the virtual object, an interaction with the virtual object, and a reference to the virtual object.

Another aspect of the disclosure provides a non-transitory computer-readable medium comprising instructions for rendering a virtual object in a virtual environment on a user device. When executed by one or more processors the instructions cause the one or more processors to determine a pose of a user. The instructions cause the one or more processors to determine a viewing area of the user in the virtual environment based on the pose. The instructions cause the one or more processors to define a viewing region within the viewing area, the viewing region having a volume described by an angular displacement from a vector extending outward from the user in the virtual environment. The instructions cause the one or more processors to identify a virtual object in the viewing area of the user. The instructions cause the one or more processors to cause the user device to display a version of a plurality of versions of the virtual object via the user device based on one or more of a distance to the virtual object, a viewing region in relation to the virtual object, an interaction with the virtual object, and a reference to the virtual object.

Other features and benefits will be apparent to one of ordinary skill with a review of the following description.

### BRIEF DESCRIPTION OF THE DRAWINGS

The details of embodiments of the present disclosure, both as to their structure and operation, can be gleaned in part by study of the accompanying drawings, in which like reference numerals refer to like parts, and in which:

FIG. 1A is a functional block diagram of an embodiment of a system for or rendering a virtual object based on one or more conditions;

FIG. 1B is a functional block diagram of another embodiment of a system for rendering a virtual object based on one or more conditions;

FIG. 2 is a graphical representation of a virtual environment for tracking positions and orientations of a user and a virtual object for use in rendering the virtual object for display to the user based on one or more conditions;

FIG. 3A and FIG. 3B are graphical representations of an embodiment of a method for determining how to render a virtual object based on one or more conditions;

FIG. 4A and FIG. 4B are graphical representations of another embodiment of a method for determining how to render a virtual object based on one or more conditions;

FIG. 5 is a flowchart of an embodiment of a process for determining how to render a virtual object based on one or more conditions.

FIG. 6A and FIG. 6B are graphical representations of embodiments of different sizes of a viewing area and a viewing region for use in determining how to render a virtual object;

FIG. 7 is a graphical representation of an embodiment of a boundary and an enclosing volume for use in determining how to render a virtual object based on one or more conditions; and

FIG. 8 is a graphical representation of one implementation of operations from FIG. 5.

### DETAILED DESCRIPTION

Different systems and methods that allow each user in a mixed reality environment to render virtual objects to be viewed and/or manipulated in the mixed reality environment from the viewpoint of each user are described in this disclosure. As each user moves around the virtual environment, that user's perspective of each virtual object changes. A renderer must determine how to update the appearance of the virtual environment on the display of a user device each time the user moves. The renderer must make these decisions and update the viewing perspective in a very short duration. If the renderer can spend less time calculating the new viewing perspective for each virtual object, the renderer can more-quickly provide the updated frames for display, which provides improved user experience, especially for user devices that have limited processing capability. Different approaches for determining how to render virtual objects are described below. Conditions are tested, and different versions of virtual objects are selected for rendering based on the results of the tested conditions. By way of example, when a user is not looking directly at a virtual object, is not in the vicinity of a virtual object, is not interacting with the virtual object, and/or does not have permission to see all details of the virtual object, a client application should not waste processing time and power on rendering a high quality version of that virtual object. Therefore, the renderer can use a reduced quality version of the virtual object to represent the virtual object for the entire time the user is not looking directly at a virtual object, is not in the vicinity of a virtual object, is not interacting with the virtual object, and/or does not have permission to see all details of the virtual object.

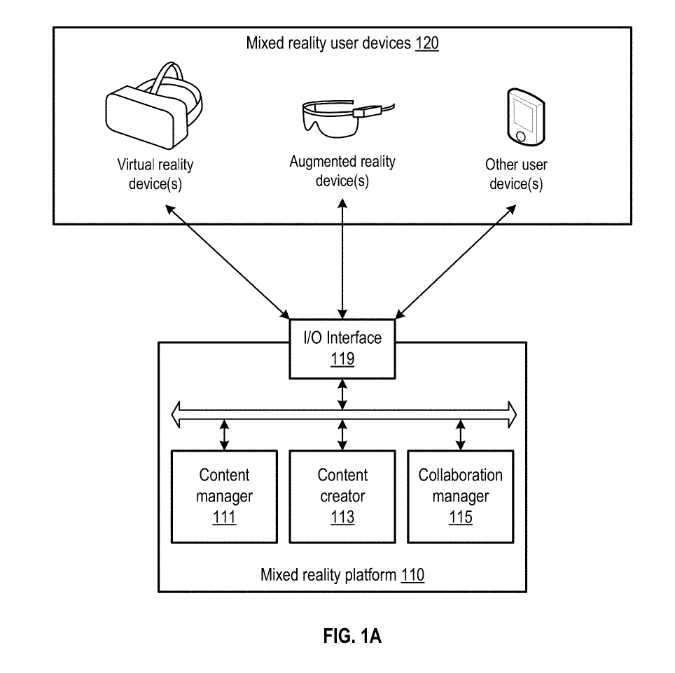

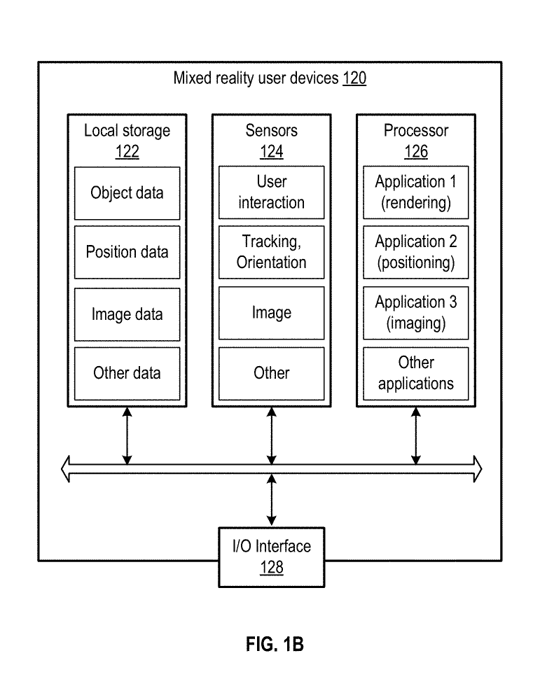

FIG. 1A and FIG. 1B are functional block diagrams of embodiments of a system for transmitting files associated with a virtual object to a user device. The transmitting can be based on different conditions. A system for creating computer-generated virtual environments and providing the virtual environments as an immersive experience for VR and AR users is shown in FIG. 1A. The system includes a mixed reality platform 110 that is communicatively coupled to any number of mixed reality user devices 120 such that data can be transferred between them as required for implementing the functionality described in this disclosure. The platform 110 can be implemented with or on a server. General functional details about the platform 110 and the user devices 120 are discussed below before particular functions involving the platform 110 and the user devices 120 are discussed.

As shown in FIG. 1A, the platform 110 includes different architectural features, including a content manager 111, a content creator 113, a collaboration manager 115, and an input/output (I/O) interface 119. The content creator 111 creates a virtual environment and visual representations of things (e.g., virtual objects and avatars) that can be displayed in a virtual environment depending on a user's point of view. Raw data may be received from any source, and then converted to virtual representations of that data. Different versions of a virtual object may also be created and modified using the content creator 111. The content manager 113 stores content created by the content creator 111, stores rules associated with the content, and also stores user information (e.g., permissions, device type, or other information). The collaboration manager 115 provides portions of a virtual environment and virtual objects to each of the user devices 120 based on conditions, rules, poses (e.g., positions and orientations) of users or avatars in a virtual environment, interactions of users with virtual objects, and other information. The I/O interface 119 provides secure transmissions between the platform 110 and each of the user devices 120. Such communications or transmissions can be enabled by a network (e.g., the Internet) or other communication link coupling the platform 110 and the user device(s) 120.

It is noted that the user of a VR/AR/MR/XR system is not technically “inside” the virtual environment. However the phrase “perspective of the user” or “position of the user” is intended to convey the view or position that the user would have (e.g., via the user device) were the user inside the virtual environment. This can also be the “position of” or “perspective the avatar of the user” within the virtual environment. It can also be the view a user would see viewing the virtual environment via the user device.

Each of the user devices 120 include different architectural features, and may include the features shown in FIG. 1B, including a local storage 122, sensors 124, processor(s) 126, and an input/output interface 128. The local storage 122 stores content received from the platform 110, and information collected by the sensors 124. The processor 126 runs different applications needed to display any virtual object or virtual environment to a user operating a user device. Such applications include rendering, tracking, positioning, 2D and 3D imaging, and other functions. The I/O interface 128 from each user device 120 manages transmissions between that user device 120 and the platform 110. The sensors 124 may include inertial sensors that sense movement and orientation (e.g., gyros, accelerometers and others), optical sensors used to track movement and orientation, location sensors that determine position in a physical environment, depth sensors, cameras or other optical sensors that capture images of the physical environment or user gestures, audio sensors that capture sound, and/or other known sensor(s). Depending on implementation, the components shown in the user devices 120 can be distributed across different devices (e.g., a worn or held peripheral separate from a processor running a client application that is communicatively coupled to the peripheral). Examples of such peripherals include head-mounted displays, AR glasses, and other peripherals.

Some of the sensors 124 (e.g., inertial, optical, and location sensors) are used to track the pose (e.g., position and orientation) of a user in virtual environments and physical environments. Tracking of user position and orientation (e.g., of a user head or eyes) is commonly used to determine view areas, and the view area is used to determine what virtual objects to render using the processor 126 for presentation to the user on a display of a user device. Tracking the positions and orientations of the user or any user input device (e.g., a handheld device) may also be used to determine interactions with virtual objects. In some embodiments, an interaction with a virtual object includes a modification (e.g., change color or other) to the virtual object that is permitted after a tracked position of the user or user input device intersects with a point of the virtual object in a geospatial map of a virtual environment, and after a user-initiated command is provided to make the desired modification.

Some of the sensors 124 (e.g., cameras and other optical sensors of AR devices) may also be used to capture information about a physical environment, which is used to generate virtual representations of that information, or to generate geospatial maps of the physical environment that can be used to determine where and how to present virtual objects among physical objects of the physical environment. Such virtual representations and geospatial maps may be created using any known approach. In one approach, many two-dimensional images are captured by a camera of an AR device, those two-dimensional images are used to identify three-dimensional points in the physical environment, and the three-dimensional points are used to determine relative positions, relative spacing and structural characteristics (e.g., surfaces and depths) of physical objects in the physical environment. Other optical sensors may be used in addition to a camera (e.g., a depth sensor). Textures, colors and other features of physical objects or physical environments can be determined by analysis of individual images.

Examples of the user devices 120 include VR, AR, and general computing devices with displays, including head-mounted displays, sensor-packed wearable devices with a display (e.g., glasses), mobile phones, tablets, desktop computers, laptop computers, or other computing devices that are suitable for carrying out the functionality described in this disclosure.

The methods or processes outlined and described herein and particularly those that follow below, can be performed by one or more processors of the platform 110 either alone or in connection with the user device(s) 120. The processes can also be performed using distributed or cloud-based computing.

### Determining How to Render a Virtual Object Based on One or More Conditions

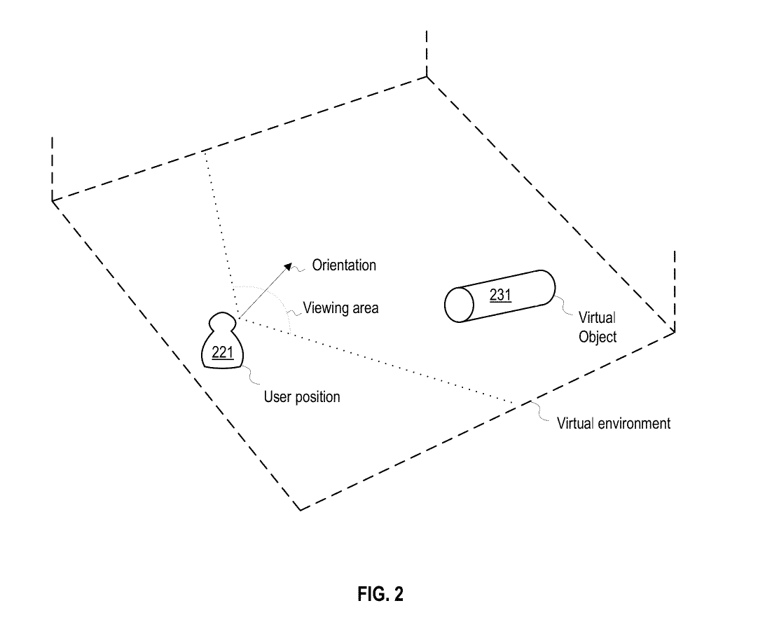

FIG. 2 is a graphical representation of a virtual environment for tracking positions and orientations of a user and a virtual object for use in rendering the virtual object for display to the user based on one or more conditions. An illustration of a virtual environment for tracking a pose of a user (e.g., a position and orientation of the user) and the pose of a virtual object (e.g., the position and orientation of the virtual object) for use in determining how to render the virtual object for display to the user based on one or more conditions is shown in FIG. 2. The tracking of both the user device 120 and the virtual object allow the user to more appropriately position the user device 120 to interact with the virtual object.

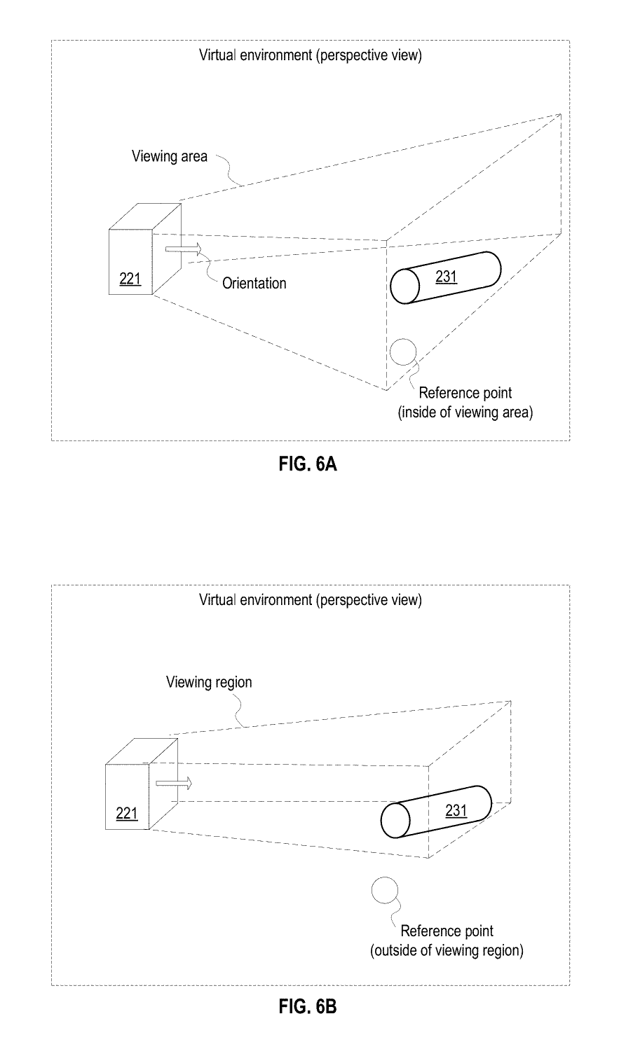

A viewing area for the user that extends from a position 221 of the user is shown. The viewing area defines parts of the virtual environment that are displayed to that user by a user device operated by the user. Example user devices include any of the mixed reality user devices 120. Other parts of the virtual environment that are not in the viewing area for a user are not displayed to the user until the user's pose changes to create a new viewing area that includes the other parts. A viewing area can be determined using different techniques known in the art. One technique involves: (i) determining the position and the orientation of a user in a virtual environment (e.g., the orientation of the user's head or eyes); (ii) determining outer limits of peripheral vision for the user (e.g., x degrees of vision in different directions from a vector extending outward along the user's orientation, where x is a number like 45 or another number depending on the display of the user device or another reason); and (iii) defining the volume enclosed by the peripheral vision as the viewing area. A volumetric viewing area is illustrated in FIG. 6A.

After a viewing area is defined, a viewing region for a user can be defined for use in some embodiments that are described later, including use in determining how to render virtual objects that are inside and outside the viewing region. A viewing region is smaller than the viewing area of the user. Different shapes and sizes of viewing regions are possible. A preferred shape is a volume (e.g., conical, rectangular or other prism) that extends from the position 221 of the user along the direction of the orientation of the user. The cross-sectional area of the volume that is perpendicular to the direction of the orientation may expand or contract as the volume extends outward from the user's position 221. A viewing region can be determined using different techniques known in the art. One technique involves: (i) determining the position and the current orientation of a user in a virtual environment (e.g., the orientation of the user's head or eyes); (ii) determining outer limits of the viewing region (e.g., x degrees of vision in different directions from a vector extending outward along the user's current orientation); and (iii) defining the volume enclosed by the outer limits as the viewing region. The value of x can vary. For example, since users may prefer to reorient their head from the current orientation to see an object that is located more than 10-15 degrees from the current orientation, the value of x may be set to 10 or 15 degrees. The value of x can be predetermined or provisioned with a given system. The value of x can also be user-defined.

By way of example, a volumetric viewing region is illustrated in FIG. 6B. The relative sizes of the viewing area and the viewing region are shown by the reference point, which is inside the larger viewing area, and outside the smaller viewing region.

As shown in FIG. 2, a virtual object 231 is inside the viewing area of the user. Therefore, the virtual object 231 will be displayed to the user. However, depending on different conditions, a lower quality version of the virtual object can be rendered for display in the viewing area. Different embodiments for determining how to render a virtual object based on one or more conditions are described below. In each embodiment, the virtual object 231 is rendered differently by a user device operated by the user depending on different conditions. In general, if the present value of a condition is a first value, then a first version of the virtual object 231 is rendered, and if the present value of the condition is a second value, then a second version of the virtual object 231 is rendered, and so on for n>1 values.

Different versions of the virtual object 231 are described herein as having different levels quality. For example, respective low and high levels of quality can be achieved by using less or more triangles or polygons, using coarse or precise meshes, using less or more colors or textures, using a static image or an animated image, removing or including details of the virtual object, pixelating or not pixelating details of the virtual object, or other different versions of features of a virtual object. In some embodiments, two versions of a virtual object are maintained by the platform 110 or the user device 120. One version is a higher quality version that is a complex representation of the virtual object and the other is a lower quality version that is a simplified representation of the virtual object. The simplified version could be lower quality in that the virtual object is a unified version of all of its components such that the lower quality version cannot be disassembled. Alternatively, the simplified version could be any of the lower levels of quality listed above, or some other version different than the complex version.

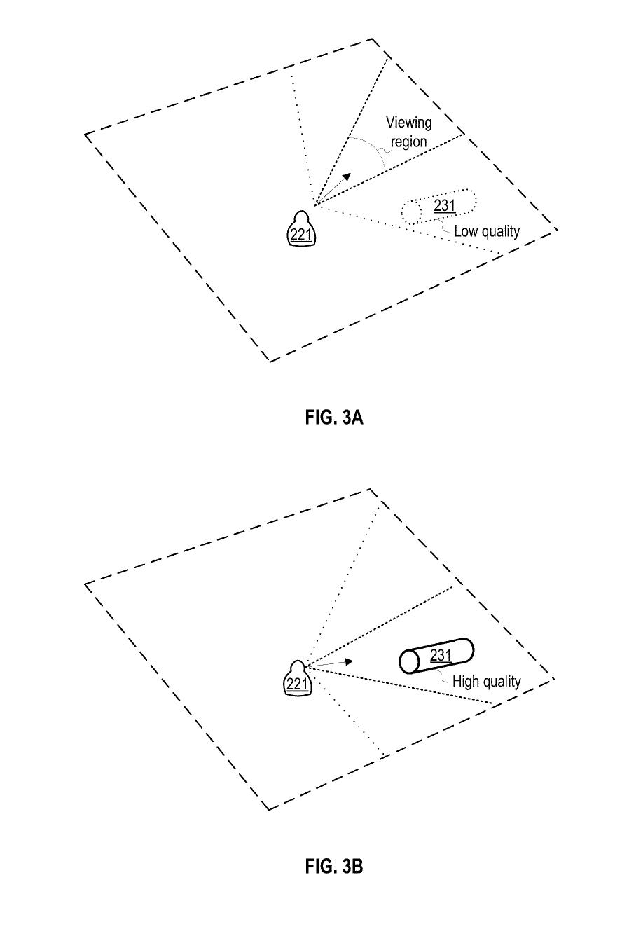

FIG. 3A and FIG. 3B are graphical representations of an embodiment of a method for determining how to render a virtual object based on one or more conditions. FIG. 3A and FIG. 3B depict different circumstances. In the first embodiment, the virtual object 231 is rendered differently by a user device operated by the user depending on if the virtual object 231 is inside or outside the viewing region of the user. As shown in FIG. 3A, when the virtual object 231 is not in the viewing region of the user, the virtual object 231 is rendered at a first level of quality (e.g., a low quality, which is relative to at least one other available level of quality that is higher in quality). As shown in FIG. 3B, when the virtual object 231 is in the viewing region of the user, the virtual object 231 is rendered at a second level of quality (e.g., a high quality, which is relative to at least one other available level of quality that is lower in quality, such as the first level of quality). When the virtual object 231 is only partially in the viewing region of the user (not shown), the virtual object 231 is rendered at either level of quality or a third level of quality depending on how the first embodiment is implemented. Alternatively, instead of using a viewing region, any way of determining where a user is looking relative to a position of a virtual object can be used.

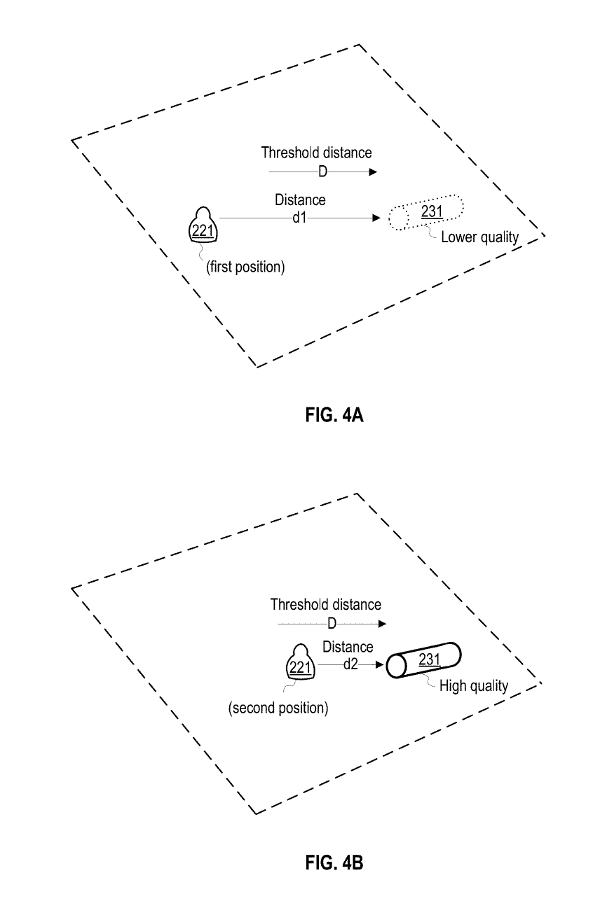

FIG. 4A and FIG. 4B are graphical representations of another embodiment of a method for determining how to render a virtual object based on one or more conditions. FIG. 4A and FIG. 4B depict different circumstances. In the second embodiment, the virtual object 231 is rendered differently by the user device depending on whether the virtual object 231 is within a threshold distance from the position 221 of the user. As shown in FIG. 4A, when the distance between the object 231 and the position 221 of the user (e.g., see d1) is more than a threshold distance D, the virtual object 231 is rendered at a first level of quality (e.g., a low quality, which is relative to at least one other available level of quality that is higher in quality). As shown in FIG. 4B, when the distance between the object 231 and the position 221 of the user (e.g., see d2) is less than the threshold distance D, the virtual object 231 is rendered at a second level of quality (e.g., a high quality, which is relative to at least one other available level of quality that is lower in quality, such as the first level of quality). When the distance between the object 231 and the position 221 of the user is equal to the threshold distance D (not shown), the virtual object 231 is rendered at either level of quality or a third level of quality depending on how the second embodiment is implemented. Different threshold distances may be used to determine different levels of quality at which to render and display the virtual object 231.

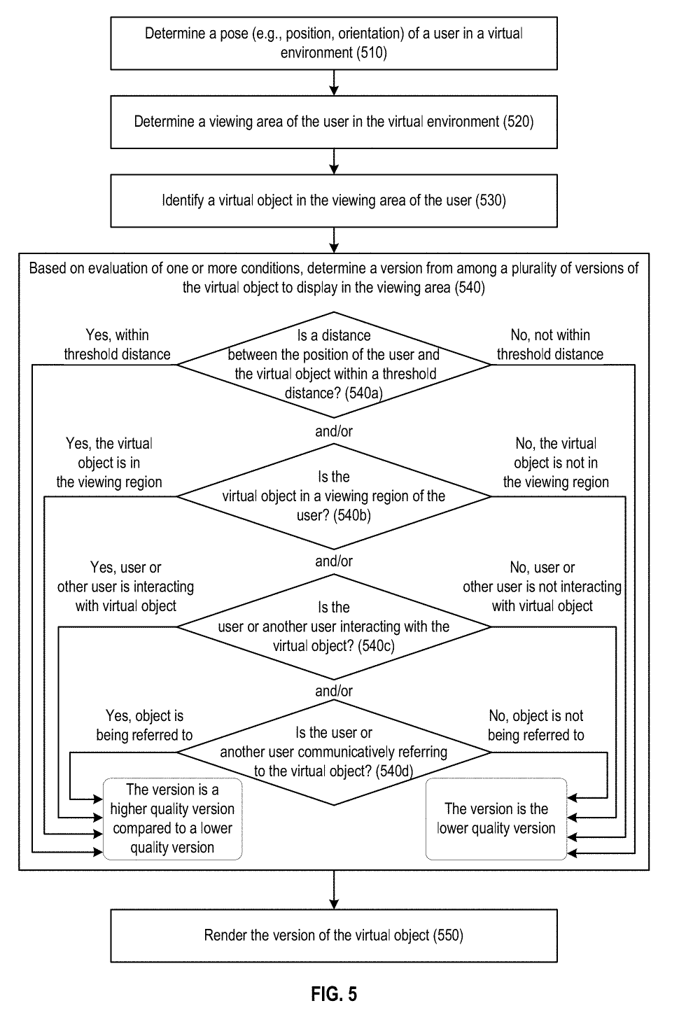

FIG. 5 is a flowchart of an embodiment of a process for determining how to render a virtual object based on one or more conditions. The process described in connection with FIG. 5, and the other processes described herein, can be performed in whole or in part by the platform 110. In some embodiments portions of the processes can be performed at the user device 120. An exemplary benefit of performing processes at the platform 110 is that the processing requirements of the user device 120 are reduced. Performing certain processing steps such as rendering the virtual environment may be required at the user device 120 for proper viewing. However in some circumstances, the platform 110 can relieve some processing burden and provide reduced resolution or otherwise simplified data files to ease processing requirements at the user device 120.

As shown, a pose (e.g., position, orientation) of a user interacting with a virtual environment is determined (510) (by, e.g., the platform 110), and a viewing area of the user in the virtual environment is determined (520)—e.g., based on the user's pose, as known in the art. A virtual object in the viewing area of the user is identified (530). Based on evaluation of one or more conditions (e.g., distance, angle, etc.), a version of the virtual object from among two or more versions of the virtual object to display in the viewing area is selected or generated (540), and the selected or generated version of the virtual object is rendered for display in the viewing area of the user (550). In some embodiments, the rendering of block 550 can be performed by the user device 120. In some other embodiments, the rendering (550) can be perform cooperatively between the platform 110 and the user device 120. Different evaluations of conditions during step 540 are shown in FIG. 5.

A first evaluation involves determining if a distance between the position of the user and the virtual object is within a threshold distance (540a). If the distance is within the threshold distance, the version is a higher quality version compared to a lower quality version. If the distance is not within the threshold distance, the version is the lower quality version.

A second evaluation involves determining if the virtual object is positioned in a viewing region of the user (540b). If the virtual object is positioned in the viewing region, the version is a higher quality version compared to a lower quality version. If the virtual object is not positioned in the viewing region, the version is the lower quality version. Alternatively, instead of determining if the virtual object is positioned in a viewing region of the user, step 540b could simply be a determination if the user is looking at the virtual object. If the user is looking at the virtual object, the version is the higher quality version. If the user is not looking at the virtual object, the version is the lower quality version.

A third evaluation involves determining if the user or another user is interacting with the virtual object (540c). If the user or another user is interacting with the virtual object, the version is a higher quality version compared to a lower quality version. If the user or another user is not interacting with the virtual object, the version is the lower quality version. By way of example, interactions may include looking at the virtual object, pointing to, modifying the virtual object, appending content (e.g., notations) to the virtual object, moving the virtual object, or other interactions.

A fourth evaluation involves determining if the user or another user is communicatively referring to the virtual object (540d). If the user or another user is communicatively referring to the virtual object (e.g., talking about or referencing the object), the version is a higher quality version compared to a lower quality version. If the user or another user is not communicatively referring to the virtual object, the version is the lower quality version. Examples of when the user or another user is communicatively referring to the virtual object include recognizing speech or text that references the virtual object or a feature of the virtual object.

Another evaluation not shown in FIG. 5 involves determining if the user has permission to view a higher quality version compared to a lower quality version. If the user has permission to view the higher quality version, the version is the higher quality version. If the user does not have permission to view the higher quality version, the version is the lower quality version.

In some embodiments of FIG. 5, only one evaluation is used. That is, a first embodiment uses only the first evaluation, a second embodiment only uses the second evaluation, and so on. In other embodiments, any combination of the evaluations are used.

In some embodiments, an invisible volume is generated around each virtual object, or an invisible boundary is generated in between the position 221 of the user and the space occupied by the virtual object 231. The size of the volume can be set to the size of the virtual object 231 or larger. The size of the boundary may vary depending on desired implementation. The volume or the boundary may be used to determine which version of the virtual object to render. For example, if the user is looking at, pointing to, or positioned at a location within the volume, then the virtual object is rendered using the higher quality version. Otherwise, the object is rendered using the lower quality version.

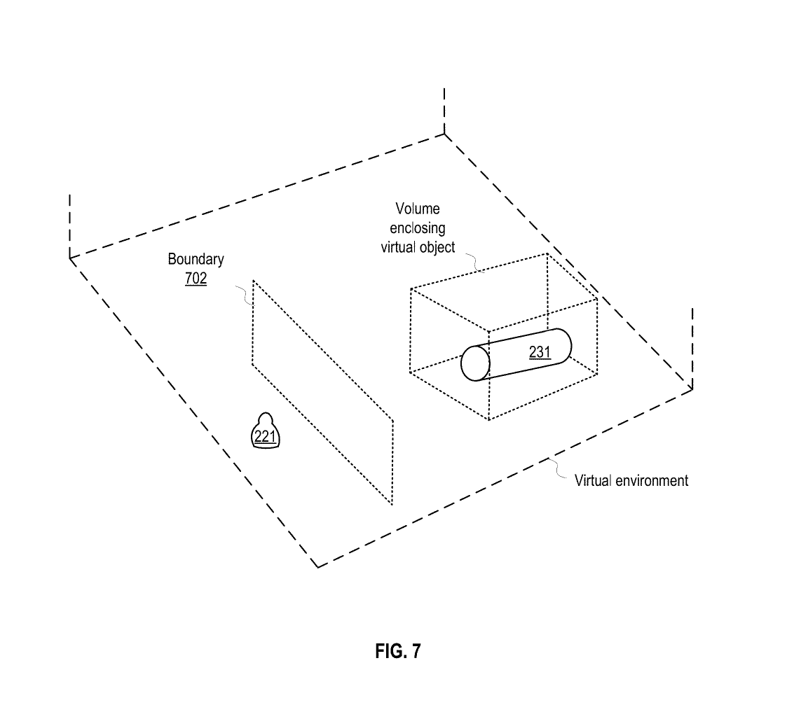

FIG. 7 is a graphical representation of an embodiment of a boundary and an enclosing volume for use in determining how to render a virtual object based on one or more conditions. In another example, if the virtual object is positioned on one side of a boundary 702, and if the user is looking at, pointing to, or positioned at a location on that same side of the boundary, then the virtual object is rendered using the higher quality version. Otherwise, the object is rendered using the lower quality version.

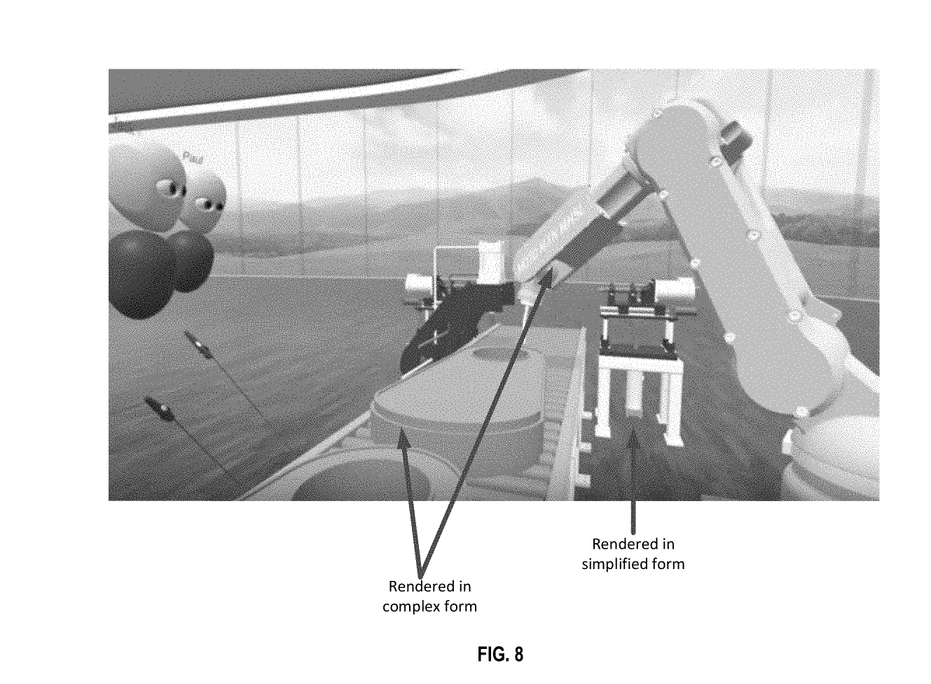

FIG. 8 is a graphical representation of one implementation of operations from FIG. 5. More specifically, FIG. 8 is a graphical representation of sub-step 540b and/or sub-step 540c of FIG. 5. A viewing area of a user as displayed to that user is depicted in FIG. 8. The user is looking at and interacting with different virtual objects that are rendered in a complex form. A virtual object in the background is rendered in a simplified form since the user is not looking at or interacting with that object. Avatars of two other users are shown to the left in the viewing area.

### Other Aspects

Methods of this disclosure may be implemented by hardware, firmware or software. One or more non-transitory machine-readable media embodying program instructions that, when executed by one or more machines, cause the one or more machines to perform or implement operations comprising the steps of any of the methods or operations described herein are contemplated. As used herein, machine-readable media includes all forms of machine-readable media (e.g. non-volatile or volatile storage media, removable or non-removable media, integrated circuit media, magnetic storage media, optical storage media, or any other storage media) that may be patented under the laws of the jurisdiction in which this application is filed, but does not include machine-readable media that cannot be patented under the laws of the jurisdiction in which this application is filed.

By way of example, machines may include one or more computing device(s), processor(s), controller(s), integrated circuit(s), chip(s), system(s) on a chip, server(s), programmable logic device(s), other circuitry, and/or other suitable means described herein (e.g., the platform 110, the user device 120) or otherwise known in the art. Systems that include one or more machines or the one or more non-transitory machine-readable media embodying program instructions that, when executed by the one or more machines, cause the one or more machines to perform or implement operations comprising the steps of any methods described herein are also contemplated.

Method steps described herein may be order independent, and can therefore be performed in an order different from that described. It is also noted that different method steps described herein can be combined to form any number of methods, as would be understood by one of skill in the art. It is further noted that any two or more steps described herein may be performed at the same time. Any method step or feature disclosed herein may be expressly restricted from a claim for various reasons like achieving reduced manufacturing costs, lower power consumption, and increased processing efficiency. Method steps can be performed at any of the system components shown in the figures.

Systems comprising one or more modules that perform, are operable to perform, or adapted to perform different method steps/stages disclosed herein are also contemplated, where the modules are implemented using one or more machines listed herein or other suitable hardware. When two things (e.g., modules or other features) are “coupled to” each other, those two things may be directly connected together, or separated by one or more intervening things. Where no lines and intervening things connect two particular things, coupling of those things is contemplated in at least one embodiment unless otherwise stated. Where an output of one thing and an input of another thing are coupled to each other, information sent from the output is received by the input even if the data passes through one or more intermediate things. Different communication pathways and protocols may be used to transmit information disclosed herein. Information like data, instructions, commands, signals, bits, symbols, and chips and the like may be represented by voltages, currents, electromagnetic waves, magnetic fields or particles, or optical fields or particles.

The words comprise, comprising, include, including and the like are to be construed in an inclusive sense (i.e., not limited to) as opposed to an exclusive sense (i.e., consisting only of). Words using the singular or plural number also include the plural or singular number, respectively. The word or and the word and, as used in the Detailed Description, cover any of the items and all of the items in a list. The words some, any and at least one refer to one or more. The term may is used herein to indicate an example, not a requirement—e.g., a thing that may perform an operation or may have a characteristic need not perform that operation or have that characteristic in each embodiment, but that thing performs that operation or has that characteristic in at least one embodiment.

What is claimed is:

1. A method for rendering a virtual object in a virtual environment on a user device, the method comprising:
determining a pose of a user;
determining a viewing area of the user in the virtual environment based on the pose;
defining a viewing region within the viewing area, the viewing region having a volume described by an angular displacement from a vector extending outward from the user in the virtual environment;
identifying a virtual object in the viewing area of the user; and
causing the user device to display a version of a plurality of versions of the virtual object via the user device based on one or more of
a distance to the virtual object,
a viewing region in relation to the virtual object,
an interaction with the virtual object, and
a reference to the virtual object.

2. The method of claim 1, wherein the pose comprises a position and an orientation within the virtual environment.

3. The method of claim 2, wherein the position and the orientation within the virtual environment are based on a position and orientation of the user device.

4. The method of claim 1 further comprising:
causing the user device to render the virtual object at a first quality if the virtual object lies outside a threshold distance of the user in the virtual environment; and
causing the user device to render the virtual object at a second quality if the virtual object lies within a threshold distance of the user in the virtual environment, the second quality being higher than the first quality.

5. The method of claim 1 further comprising:
causing the user device to render the virtual object at a first quality if the virtual object lies outside the viewing region; and
causing the user device to render the virtual object at a second quality if the virtual object lies inside the viewing region, the second quality being higher than the first quality.

6. The method of claim 1 further comprising:
causing the user device to render the virtual object at a first quality if the user is not interacting with the virtual object in the virtual environment; and
causing the user device to render the virtual object at a second quality if the user is interacting with the virtual object in the virtual environment, the second quality being higher than the first quality.

7. The method of claim 1 further comprising:
causing the user device to render the virtual object at a first quality if the user is not referring to the virtual object in the virtual environment; and
causing the user device to render the virtual object at a second quality if the user is referring to the virtual object in the virtual environment, the second quality being higher than the first quality.

8. The method of claim 1 further comprising:
establishing, by the server, a boundary within the virtual environment;
if the boundary is disposed between the virtual object and the user within the virtual environment, causing the user device to render the virtual object at a first quality; and
if the virtual object and the user are disposed on the same side of the boundary within the virtual environment, causing the user device to render the virtual object at a second quality higher than the first quality.

9. The method of claim 8, wherein the boundary comprises a geometric volume within the virtual environment.

10. A non-transitory computer-readable medium comprising instructions for rendering a virtual object in a virtual environment on a user device that when executed by one or more processors cause the one or more processors to:
determine a pose of a user;
determine a viewing area of the user in the virtual environment based on the pose;
define a viewing region within the viewing area, the viewing region having a volume described by an angular displacement from a vector extending outward from the user in the virtual environment;
identify a virtual object in the viewing area of the user; and
cause the user device to display a version of a plurality of versions of the virtual object via the user device based on one or more of
a distance to the virtual object,
a viewing region in relation to the virtual object,
an interaction with the virtual object, and
a reference to the virtual object.

11. The non-transitory computer-readable medium of claim 10, wherein the pose comprises a position and an orientation within the virtual environment.

12. The non-transitory computer-readable medium of claim 11, wherein the position and the orientation within the virtual environment are based on a position and orientation of the user device.

13. The non-transitory computer-readable medium of claim 10 further comprising instructions that cause the one or more processors to:
cause the user device to render the virtual object at a first quality if the virtual object lies outside a threshold distance of the user in the virtual environment; and
cause the user device to render the virtual object at a second quality if the virtual object lies within a threshold distance of the user in the virtual environment, the second quality being higher than the first quality.

14. The non-transitory computer-readable medium of claim 10 further comprising instructions that cause the one or more processors to:
cause the user device to render the virtual object at a first quality if the virtual object lies outside the viewing region; and
cause the user device to render the virtual object at a second quality if the virtual object lies inside the viewing region, the second quality being higher than the first quality.

15. The non-transitory computer-readable medium of claim 10 further comprising instructions that cause the one or more processors to:
cause the user device to render the virtual object at a first quality if the user is not interacting with the virtual object in the virtual environment; and
cause the user device to render the virtual object at a second quality if the user is interacting with the virtual object in the virtual environment, the second quality being higher than the first quality.

16. The non-transitory computer-readable medium of claim 1 further comprising instructions that cause the one or more processors to:
cause the user device to render the virtual object at a first quality if the user is not referring to the virtual object in the virtual environment; and
cause the user device to render the virtual object at a second quality if the user is referring to the virtual object in the virtual environment, the second quality being higher than the first quality.

17. The non-transitory computer-readable medium of claim 10 further comprising instructions that cause the one or more processors to:
establish, by the server, a boundary within the virtual environment;
if the boundary is disposed between the virtual object and the user within the virtual environment, cause the user device to render the virtual object at a first quality; and
if the virtual object and the user are disposed on the same side of the boundary within the virtual environment, cause the user device to render the virtual object at a second quality higher than the first quality.

18. The non-transitory computer-readable medium of claim 17, wherein the boundary comprises a geometric volume within the virtual environment.
